(19) United States
(12) Patent Application Publication
(10) Pub. No.: US 2026/0303665 A1
(43) Pub. Date: Oct. 1, 2026

(54) Efficient Hardware Resource Utilization for 802.1X Authentication

(71) Applicant: Arista Networks, Inc., Santa Clara, CA (US)

(72) Inventors: Basil Saji, Bangalore (IN); Krishna S, Bangalore (IN); Vishal Bandekar, Bangalore (IN); Milind Kulkarni, Bangalore (IN); Pratishtha Panwar, Bangalore (IN)

(21) Appl. No.: 19/095,703

(22) Filed: Mar. 31, 2025

(51) Int. Cl. H04L 9/40

(52) U.S. Cl. CPC H04L 63/20; H04L 63/0884

(57) ABSTRACT

Techniques for implementing 802.1X authentication in a manner that optimizes hardware resource usage on authenticator devices are provided. In certain embodiments, these techniques reduce the number of ternary content-addressable memory (TCAM) rules that are programmed for unauthenticated hosts in an authenticator device from O(N) to O(1), where N is the number of interfaces on the authentication device that have 802.1X authentication enabled.

### BACKGROUND

802.1X is a network access control protocol standardized by the Institute of Electrical and Electronics Engineers (IEEE) that provides authentication of client devices (i.e., hosts) attempting to connect to a computer network. Network devices that implement 802.1X authentication, known as authenticator devices, typically employ ternary content-addressable memory (TCAM) rules for regulating the flow of network traffic from authenticated and unauthenticated hosts.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network deployment in accordance with certain embodiments of the present disclosure.

FIG. 2 depicts an example authenticator device in accordance with certain embodiments of the present disclosure.

FIG. 3 depicts a default TCAM rule programming workflow in accordance with certain embodiments of the present disclosure.

FIG. 4 depicts a packet processing workflow in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for implementing 802.1X authentication in a manner that optimizes hardware resource usage on authenticator devices. In certain embodiments, these techniques reduce the number of TCAM rules that are programmed for unauthenticated hosts in an authenticator device from O(N) to O(1), where N is the number of interfaces on the authentication device that have 802.1X authentication enabled (referred to as 802.1X-configured interfaces).

### 1. Example Network Deployment and Authenticator Device

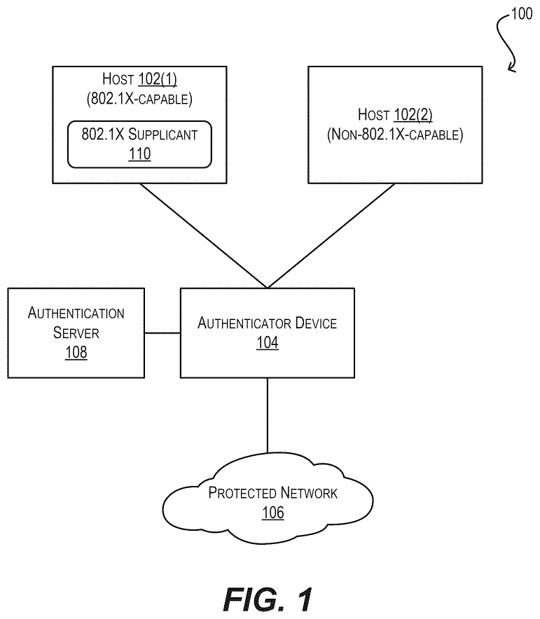

FIG. 1 is a simplified block diagram of an example network deployment 100 in which the techniques of the present disclosure may be implemented. As shown, network deployment 100 includes two client devices (hosts) 102(1) and 102(2) that are communicatively coupled with an authenticator device 104. Authenticator device 104 is in turn coupled with a protected network 106. Authenticator device 104 is a network device (e.g., a switch or wireless access point (AP)) that implements 802.1X authentication for the purpose of controlling host access to protected network 106 (such that authenticated hosts are allowed network access and unauthenticated hosts are denied network access). Authenticator device 104 carries out this authentication with the help of an authentication (e.g., RADIUS) server 108.

Authenticator devices like device 104 typically support two methods of authentication on a per-interface basis: Extensible Authentication Protocol (EAP)-based authentication (hereinafter EAP) and Media Access Control (MAC)-based authentication (hereinafter MBA). EAP, which is part of the IEEE 802.1X standard and is enabled by default on 802.1X-configured interfaces, is designed to authenticate hosts that run 802.1X client (supplicant) software, or in other words are 802.1X-capable. For example, in FIG. 1, host 102(1) runs an 802.1X supplicant 110 and thus authenticator device 104 would use EAP to authenticate host 102(1). The EAP authentication process generally proceeds as follows (this workflow assumes the authentication is performed with respect to host 102(1)):
1. Host 102(1) connects to an 802.1X-configured interface of authenticator device 104
2. Because host 102(1) is not yet authenticated (i.e., is an unauthenticated host), authenticator device 104 temporarily blocks host 102(1)'s access to protected network 106 and sends an EAP request to the host
3. Supplicant 110 running on host 102(1) responds to the EAP request with the host's EAP credentials (e.g., a username and password, a certificate, etc.)
4. Authenticator device 104 receives the credentials and forwards them to authentication server 108
5. Authentication server 108 verifies the host's EAP credentials and based on this verification, provides an authentication result (success or failure) to authenticator device 104
6. If the authentication result indicates success, authenticator device 104 grants host 102(1) access to protected network 106; alternatively, if the authentication result indicates failure, authenticator device 104 denies network access to host 102(1)

In contrast to EAP, MBA is a non-standardized (i.e., vendor specific) authentication method that can be selectively enabled or disabled on 802.1X-configured interfaces and is designed as a fallback from EAP for authenticating hosts that do not run 802.1X supplicant software (i.e., non-802.1X-capable hosts). For example, in FIG. 1, host 102(2) is non-802.1X-capable and thus authenticator device 104 would use MBA to authenticate host 102(2). MBA is needed for non-802.1X-capable hosts because such hosts cannot provide EAP credentials as required by EAP. The MBA authentication process generally proceeds as follows (this workflow assumes the authentication is performed with respect to host 102(2)):
1. Host 102(2) connects to an 802.1X-configured interface of authenticator device 104, where the interface has MBA enabled (which means that the interface supports EAP as a primary authentication method and MBA as a secondary/fallback authentication method)
2. Because host 102(2) is not yet authenticated (i.e., is an unauthenticated host), authenticator device 104 temporarily blocks host 102(2)'s access to protected network 106 and sends an EAP request to the host
3. Host 102(2) does not respond to the EAP request, due to being non-802.1X-capable
4. Authenticator device 104 detects that no EAP response has been received from host 102(2) and falls back to MBA, which involves extracting the host's MAC address from the data packet(s) received from the host and sending the MAC address to authentication server 108
5. Authentication server 108 verifies the host's MAC address and based on this verification, provides an authentication result (success or failure) to authenticator device 104
6. If the authentication result indicates success, authenticator device 104 grants host 102(2) access to protected network 106; alternatively, if the authentication result indicates failure, authenticator device 104 denies network access to host 102(2)

In addition to the two authentication methods above, authenticator device 104 supports several host modes that control how the device handles multiple hosts connecting to a single 802.1X-configured interface. These host modes include:
Single-host mode: For interfaces that are configured in this mode, once a host is authenticated on the interface, only traffic coming from that single host's MAC address is allowed through the interface
Multi-host mode: For interfaces that are configured in this mode, once a host is authenticated on the interface, traffic coming from any host (with any source MAC address) is allowed through the interface
Multi-host authenticated mode: For interfaces that are configured in this mode, multiple hosts can be authenticated on the interface and only traffic coming from those authenticated hosts' MAC addresses is allowed through the interface

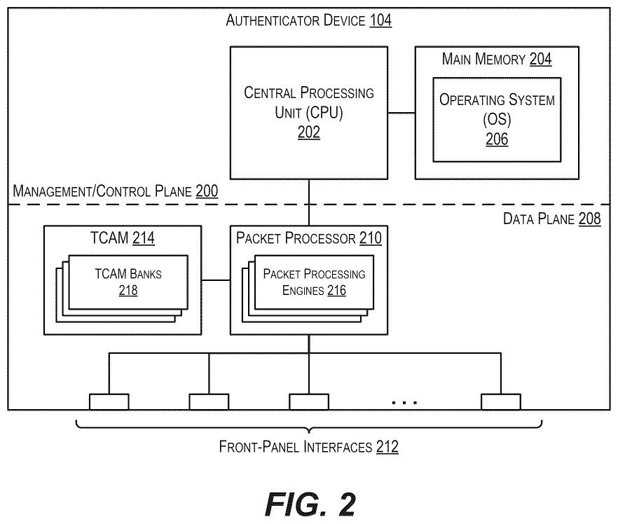

FIG. 2 is a simplified block diagram illustrating the architecture of authenticator device 104 of FIG. 1 according to certain embodiments. FIG. 2 assumes that authenticator device 104 is a wired network device, such as a wired switch, rather than a wireless network device. One of ordinary skill in the art will appreciate that the architecture depicted in FIG. 2 can be modified to support wireless networking capabilities.

As shown, authenticator device 104 includes a management/control plane 200 comprising a central processing unit (CPU) 202 and a main memory 204. CPU 202 is a general-purpose processor that is responsible for managing the configuration/operation of authenticator device 104, including orchestrating the EAP and MBA authentication methods described above. CPU 202 carries out these functions under the direction of an operating system (OS) 206 that runs on CPU 202 from main memory 204.

Authenticator device 104 also includes a data (or forwarding) plane 208 comprising a packet processor 210, a set of front-panel interfaces 212, and a TCAM 214. Packet processor 210 is an integrated circuit, such as an application-specific integrated circuit (ASIC) or field-programmable gate array (FPGA), that is responsible for performing line-speed processing of network packets (i.e., traffic) that pass through authenticator device 104 via interfaces 212. Packet processor 210 executes this line-speed processing using a number of packet processing engines 216, each of which is configured to handle traffic for a particular subset of interfaces 212. For example, in a scenario where there are three packet processing engines and twelve interfaces, the first packet processing engine may be configured to process all traffic passing through the first four interfaces, the second packet processing engine may be configured to process all traffic passing through the next four interfaces, and the third packet processing engine may be configured to process all traffic passing through the last four interfaces.

TCAM 214 is a type of high-speed memory that holds rules which control the manner in which packet processor 210 and its constituent engines 216 perform their packet processing duties. These TCAM rules are programmed into TCAM 214 by CPU 202 (in accordance with the software of OS 206) and are organized into TCAM banks 218 that are mapped to packet processing engines 216. Generally speaking, each TCAM rule includes (1) a match key that specifies one or more packet match criteria and a corresponding match value and (2) one or more actions. In addition, each TCAM rule is associated with a priority (which is typically derived from its order in the TCAM). When a packet processing engine 216 receives a packet to be processed, the engine attempts to match the packet's header to the match keys of the TCAM rules programmed into the TCAM bank(s) mapped to that engine. Upon matching the packet to one or more TCAM rules, the packet processing engine executes the action(s) included in the highest-priority matched rule on the packet.

### 2. Problem Statement

As noted in the Background section, authenticator devices like device 104 of FIGS. 1 and 2 typically regulate (e.g., block or allow) network traffic from authenticated and unauthenticated hosts via TCAM rules that are programmed into its TCAM. For example, assume authenticator device 104 has six 802.1X-configured interfaces 212(1)-(6) where interfaces 212(2), 212(3), 212(5), and 212(6) only support EAP (or in other words, have MBA disabled) and interfaces 212(1) and 212(4) support both EAP and MBA (or in other words, have MBA enabled). Further, assume that a first host H1 with MAC address 00:00:11:11:11:11 and VLAN ID 1 is authenticated on interface 212(1), a second host H2 with MAC address 00:00:22:22:22:22 and VLAN ID 2 is authenticated on interface 212(2), and a third host H3 with MAC address 00:00:22:22:22:23 and VLAN ID 2 is authenticated on interface 212(4). In this scenario, the following TCAM rules will be conventionally programmed into a TCAM bank 218 of authenticator device 104. This example assumes that interfaces 212(1)-(6) are all managed by a single packet processing engine 216 of packet processor 210 (and thus the TCAM rules pertaining to these interfaces are all programmed into the same TCAM bank) and that interfaces 212(1)-(6) are configured in single-host or multi-host authenticated mode.

TABLE 1

| Rule | Match Key | Action |
|---|---|---|
| R1 | MAC = 00:00:11:11:11:11, VLAN_ID = 1, SRC_PORT = 1 | Noop/forward |
| | (for interface 212(1)) | |
| R2 | MAC = 00:00:22:22:22:22, VLAN_ID = 2, SRC_PORT = 2 | Noop/forward |
| | (for interface 212(2)) | |
| R3 | MAC = 00:00:22:22:22:23, VLAN_ID = 2, SRC_PORT = 4 | Noop/forward |
| | (for interface 212(4)) | |
| R4 | MAC = XX:XX:XX:XX:XX:XX (any MAC), SRC_PORT = 1 | Trap |
| | (for interface 212(1)) | |
| R5 | MAC = XX:XX:XX:XX:XX:XX (any MAC), SRC_PORT = 2 | Drop |
| | (for interface 212(2)) | |
| R6 | MAC = XX:XX:XX:XX:XX:XX (any MAC), SRC_PORT = 3 | Drop |
| | (for interface 212(3)) | |
| R7 | MAC = XX:XX:XX:XX:XX:XX (any MAC), SRC_PORT = 4 | Trap |
| | (for interface 212(4)) | |
| R8 | MAC = XX:XX:XX:XX:XX:XX (any MAC), SRC_PORT = 5 | Drop |
| | (for interface 212(5)) | |
| R9 | MAC = XX:XX:XX:XX:XX:XX (any MAC), SRC_PORT = 6 | Drop |
| | (for interface 212(6)) | |

Rules R1-R3 above (which are the highest priority rules and thus get matched first) pertain to authenticated hosts H1, H2, and H3 and the “noop” (no operation)/“forward” action specified in these rules means that network traffic from those authenticated hosts is allowed to pass through their corresponding interfaces 212(1), 212(2), and 212(4). Rules R4-R9 (which get matched after R1-R3) pertain to unauthenticated hosts that attempt to send data packets to interfaces 212(1)-(6) respectively and either drop those packets or trap the packets to CPU 202 of authenticator device 104, depending on the authentication method configured on the interface.

In particular, because interfaces 212(2), 212(3), 212(5), and 212(6) only support EAP (i.e., have MBA disabled), rules R5, R6, R8, and R9 drop all data packets from unauthenticated hosts on these interfaces. The reason for this is that CPU 202 of authenticator device 104 only needs to receive and process EAP control packets from unauthenticated hosts on interfaces 212(2), 212(3), 212(5), and 212(6) in order to carry out the EAP authentication process. Such EAP control packets are trapped to the CPU via a separate TCAM rule, not shown in Table 1, that matches on a special IEEE multicast destination MAC address. CPU 202 has no need to look at data packets from unauthenticated hosts on 802.1X-configured interfaces that are EAP-only.

In contrast, because interfaces 212(1) and 212(4) support both EAP and MBA (i.e., have MBA enabled), rules R4 and R7 trap all data packets from unauthenticated hosts on these interfaces to CPU 202 (which means that the data packets are forwarded to the CPU). The reason for this is that CPU 202 needs to receive data packets from unauthenticated hosts on MBA-enabled interfaces in order to extract their MAC addresses and thereby carry out the MBA authentication process (if fallback from EAP is required).

One issue with the conventional TCAM rule set shown in Table 1 is that a separate TCAM rule is programmed for every 802.1X-configured interface on authenticator device 104 in order to handle unauthenticated hosts (i.e., six rules R4-R9 for six 802.1X-configured interfaces 212(1)-(6) respectively). This is undesirable because TCAM is typically a scarce resource and there may be many (e.g., hundreds or more) 802.1X-configured interfaces on authenticator device 104 in real-world scenarios. This can lead to a situation where authenticator device 104's TCAM 214 is not large enough to hold all of the TCAM rules needed for 802.1X authentication and the other networking functions of device 104 that consume TCAM (e.g., access control lists, Quality-of-Service policies, and so on).

### 3. Solution Overview

To address the foregoing and other similar problems, embodiments of the present disclosure provide techniques that advantageously reduce the number of TCAM rules that are programmed for unauthenticated hosts in authenticator device 104 from N (where N is the number of 802.1X-configured interfaces) to only two. This efficiency is achieved on a per-engine basis of the authenticator device's packet processor 210 because each packet processor engine 216 uses a separate set of TCAM banks 218 (and thus, a separate set of TCAM rules) for the interfaces assigned to that engine. For example, if authenticator device 104 has a total of twelve 802.1X-configured interfaces 212(1)-(12) where 212(1)-(4) are assigned to a first packet processing engine 216(1) and 212(5)-212(12) are assigned to a second packet processing engine 216(2), the techniques described herein will reduce the number of TCAM rules needed in the TCAM bank(s) of engine 216(1) by 2 (4 minus 2) and the number of TCAM rules needed the TCAM bank(s) of engine 216(2) by 6 (8 minus 2).

At a high level, the techniques involve the following:
1. In each set of TCAM banks mapped to each packet processing engine 216, CPU 202 programs two default TCAM rules to handle data traffic from unauthenticated hosts: a first default TCAM rule (for MBA) that matches a first label L1 corresponding to data packets received on 802.1X-configured interfaces with MBA enabled and traps the matched packets to CPU 202, and a second default TCAM rule (for EAP) that matches a second label L2 corresponding to data packets received on 802.1X-configured interfaces with MBA disabled and drops the matched packets. These two default rules are programmed below (i.e., with lower priority than) the TCAM rules used for allowing data traffic from authenticated hosts.
2. At a time a data packet is received on an 802.1X-configured interface that is configured in single-host mode, multi-host authenticated mode, or multi-host mode with no prior host authentications, the packet processing engine assigned to that interface tags the packet with either label L1 or L2, depending on whether MBA is enabled or disabled on the interface. In the case where the data packet is received on a non-802.1X-configured interface or a 802.1X-configured interface configured in multi-host mode with a prior host authentication, the packet processing engine tags the packet with some other label L3 that is different from L1 and L2. Then, once the tagged packet reaches the TCAM matching stage, the packet processing engine attempts to match the packet against the TCAM rules programmed into the engine's TCAM bank(s). If the packet originated from an authenticated host, it will match a TCAM rule that allows traffic from that host. However, if the packet originated from an unauthenticated host, it will match one of the two default TCAM rules (based on whether the ingress interface has MBA enabled or not) and will be trapped or dropped accordingly.

Returning to the example of Table 1 above, these techniques will result in the following TCAM rules being programmed for interfaces 212(1)-(6). As shown below, rules R4-R9 from Table 1 (which are per-interface rules for handling unauthenticated hosts) are replaced by two default rules R4 and R5, thereby reducing the total rule count from nine to five.

TABLE 2

| Rule | Match Key | Action |
|---|---|---|
| R1 | MAC = 00:00:11:11:11:11, VLAN_ID = 1, SRC_PORT = 1 | Noop/forward |
| | (for interface 212(1)) | |
| R2 | MAC = 00:00:22:22:22:22, VLAN_ID = 2, SRC_PORT = 2 | Noop/forward |
| | (for interface 212(2)) | |
| R3 | MAC = 00:00:22:22:22:23, VLAN_ID = 2, SRC_PORT = 4 | Noop/forward |
| | (for interface 212(4)) | |
| R4 | MAC = XX:XX:XX:XX:XX:XX (any MAC), LABEL = L1 | Trap |
| | (for MBA) | |
| R5 | MAC = XX:XX:XX:XX:XX:XX (any MAC), LABEL = L2 | Drop |
| | (for EAP) | |

The remaining sections of this disclosure provide workflows for implementing the solution of the present disclosure. It should be appreciated that FIGS. 1 and 2 and the foregoing high-level solution description are illustrative and not intended to be limiting. For example, although FIG. 2 depicts a particular arrangement of components in authenticator device 104, other arrangements are possible (e.g., the functionality attributed to a particular component may be split into multiple components, components may be combined, etc.). One of ordinary skill in the art will recognize other similar modifications, variations, and alternatives.

Further, although the foregoing description uses the term “interface” in the context of physical front-panel interfaces 212 of authenticator device 104, “interface” may also refer to a logical interface of an authenticator device, such as a virtual interface, a port channel (also known as a link aggregation group or LAG), or a sub-interface. In such embodiments, MBA can be enabled or disabled for each 802.1X-configured logical interface and the techniques of the present disclosure can be used to reduce the number of TCAM rules that need to be programmed for unauthenticated hosts with respect to those 802.1X-configured logical interfaces.

### 4. Default Rule Programming

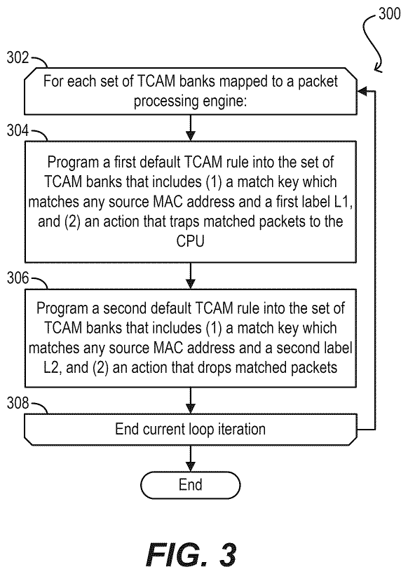

FIG. 3 depicts a workflow 300 that may be executed by authenticator device 104 for programming the default TCAM rules mentioned previously into the device's TCAM 214 according to certain embodiments. Workflow 300 may be carried by CPU 202 of authenticator device 104 in accordance with program code held in main memory 204, such as one or more components of OS 206.

Starting with step 302, authenticator device 104 can enter a loop for each set of TCAM banks mapped to a packet processing engine 216 of packet processor 210. Within this loop, authenticator device 104 can program a first default TCAM rule into the set of TCAM banks that includes (1) a match key which matches any source MAC address and a first label L1, and (2) an action that traps matched packets to CPU 202 (step 304). This first default TCAM rule is intended to handle data packets from unauthenticated hosts that are received on an 802.1X-configured interface which has MBA enabled (or in other words, supports both EAP and MBA).

Further, at step 306, authenticator device 104 can program a second default TCAM rule into the set of TCAM banks that includes (1) a match key which matches any source MAC address and a second label L2, and (2) an action that drops matched packets. This second default TCAM rule is intended to handle data packets from unauthenticated hosts that are received on an 802.1X-configured interface which has MBA disabled (or in other words, supports EAP only).

As noted in section (3) above, these first and second default TCAM rules should be programmed below any TCAM rules that are intended for authenticated hosts, to ensure that network traffic originating from such authenticated hosts is allowed/forwarded.

Finally, at step 308, authenticator device 104 can reach the end of the current loop iteration and return to the top of the loop to process the next set of TCAM banks. Upon processing all such sets, workflow 300 can end.

### 5. Packet Processing

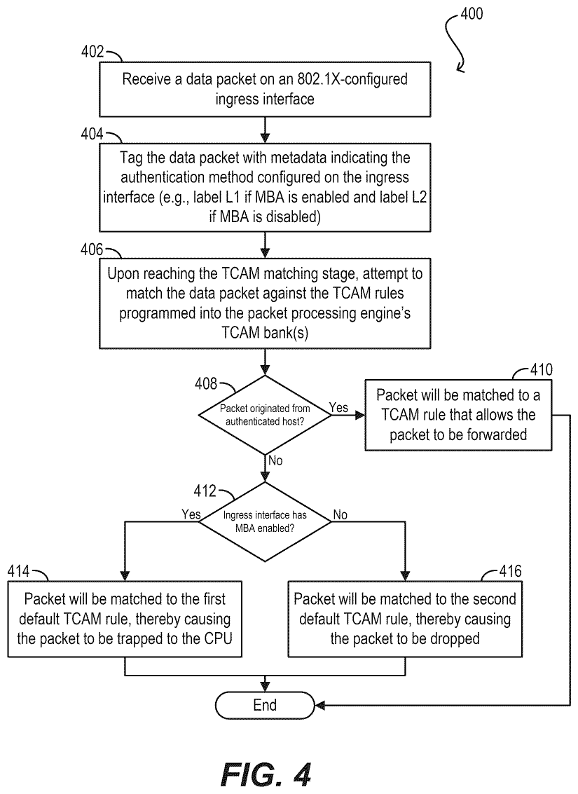

FIG. 4 depicts a workflow 400 that may be executed by authenticator device 104 for processing a data packet that is received from an authenticated or unauthenticated host on an 802.1X-configured ingress interface according to certain embodiments. Workflow 400 is carried out by a packet processing engine 216 of packet processor 210 that is assigned to handle traffic on that ingress interface. Workflow 400 assumes that the TCAM bank(s) of the packet processing engine have been programmed with the two default TCAM rules per workflow 300 of FIG. 3.

Starting with steps 402 and 404, packet processing engine 216 can receive the data packet and tag the packet with metadata indicating the authentication method configured on the 802.1X-configured ingress interface. This metadata can include label L1 if the ingress interface has MBA enabled and label L2 if the ingress interface has MBA disabled. Note that if the ingress interface does not have 802.1X configured (or the ingress interface is configured in multi-host mode and a host has previously been authenticated on the interface), the packet may be tagged with a third label L3 different from L1 and L2 (or with no label at all). This ensures that the packet is not matched to either of the first or second default rules in these specific scenarios.

At step 406, the tagged packet can reach a TCAM matching stage of packet processing engine 216, at which point the engine can attempt to match the tagged packet against the TCAM rules programmed into the engine's TCAM banks. If the data packet originated from an authenticated host (step 408), the packet will be matched to a TCAM rule that allows the packet to be forwarded (step 410).

However, if the data packet originated from an unauthenticated host, the packet will be either (1) matched to the first default TCAM rule in the scenario where the ingress interface has MBA enabled (because the packet will have been tagged with label L1), which will cause the packet to be trapped to CPU 202 (steps 412 and 414), or (2) matched to the second default TCAM rule in the scenario where the ingress interface has MBA disabled (because the packet will have been tagged with label L2), which will cause the packet to be dropped (steps 412 and 416). Workflow 400 can thereafter end.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device, the method comprising:
receiving a data packet on an interface of the network device;
upon determining that the interface is configured with 802.1X authentication and has both Extensible Authentication Protocol-based authentication (EAP) and Media Access Control-based authentication (MBA) enabled, tagging the data packet with a first label; and
upon determining that the interface is configured with 802.1X authentication and has only Extensible Authentication Protocol-based authentication (EAP) enabled, tagging the data packet with a second label different from the first label.

2. The method of claim 1 wherein a ternary-content addressable memory (TCAM) of the network device is programmed with:
a first TCAM rule including a first match key that matches on the first label and a first action that traps matched packets to a central processing unit (CPU) of the network device; and
a second TCAM rule including a second match key that matches on the second label and a second action that drops matched packets.

3. The method of claim 2 wherein the first and second TCAM rules have lower priority than other TCAM rules in the TCAM that allow traffic from authenticated hosts.

4. The method of claim 2 wherein the data packet originated from an unauthenticated host.

5. The method of claim 4 wherein, in a first scenario where the interface is configured with 802.1X authentication and has both EAP and MBA enabled, the method further comprises:
matching the data packet to the first TCAM rule, thereby causing the data packet to be trapped to the CPU in accordance with the first action.

6. The method of claim 4 wherein, in a second scenario where the interface is configured with 802.1X authentication and has only EAP enabled, the method further comprises:
matching the data packet to the second TCAM rule, thereby causing the data packet to be dropped in accordance with the second action.

7. The method of claim 1 further comprising:
upon determining that the interface is not configured with 802.1X authentication, tagging the data packet with a third label different from the first and second labels.

8. The method of claim 2 wherein the data packet originated from an authenticated host and wherein the data packet is not matched to either the first TCAM rule or the second TCAM rule.

9. The method of claim 1 wherein the network device is an authenticator device that communicates with an authentication server to implement 802.1X authentication.

10. A network device comprising:
a processor;
a ternary content-addressable memory (TCAM);
a plurality of interfaces; and
a memory have stored thereon program code that, when executed by the processor, causes the processor to:
receive a data packet on an interface in the plurality of interfaces;
upon determining that the interface is configured with 802.1X authentication and has both Extensible Authentication Protocol-based authentication (EAP) and Media Access Control-based authentication (MBA) enabled, tag the data packet with a first label; and
upon determining that the interface is configured with 802.1X authentication and has only Extensible Authentication Protocol-based authentication (EAP) enabled, tag the data packet with a second label different from the first label.

11. The network device of claim 10 wherein the TCAM is programmed with:
a first TCAM rule including a first match key that matches on the first label and a first action that traps matched packets to the processor; and
a second TCAM rule including a second match key that matches on the second label and a second action that drops matched packets.

12. The network device of claim 11 wherein the first and second TCAM rules have lower priority than other TCAM rules in the TCAM that allow traffic from authenticated hosts.

13. The network device of claim 11 wherein the data packet originated from an unauthenticated host.

14. The network device of claim 13 wherein, in a first scenario where the interface is configured with 802.1X authentication and has both EAP and MBA enabled, the program code further causes the processor to:
match the data packet to the first TCAM rule, thereby causing the data packet to be trapped to the processor in accordance with the first action.

15. The network device of claim 13 wherein, in a second scenario where the interface is configured with 802.1X authentication and has only EAP enabled, the program code further causes the processor to:
match the data packet to the second TCAM rule, thereby causing the data packet to be dropped in accordance with the second action.

16. The network device of claim 10 wherein the program code further causes the processor to:
upon determining that the interface is not configured with 802.1X authentication, tag the data packet with a third label different from the first and second labels.

17. The network device of claim 11 wherein the data packet originated from an authenticated host and wherein the data packet is not matched to either the first TCAM rule or the second TCAM rule.

18. The network device of claim 10 wherein the network device is an authenticator device that communicates with an authentication server to implement 802.1X authentication.

19. A method performed by a network device, the method comprising:
for each set of TCAM banks that is mapped to a packet processing engine of the network device:
programming a first TCAM rule into the set of TCAM banks, the first TCAM rule including a first match key that matches on a first label and a first action that traps matched packets to a central processing unit (CPU) of the network device, the first label being associated with data packets that are received by the network device from unauthenticated hosts on an 802.1X-configured interface with both Extensible Authentication Protocol-based authentication (EAP) and Media Access Control-based authentication (MBA) enabled; and
programming a second TCAM rule into the set of TCAM banks, the second TCAM rule including a second match key that matches on a second label and a second action that drops matched packets, the second label being associated with data packets that are received by the network device from unauthenticated hosts on an 802.1X-configured interface with only EAP enabled.

20. The method of claim 19 further comprising:
receiving a data packet from an unauthenticated host; and
matching the data packet to either the first TCAM rule or the second TCAM rule.
